(19) United States
(12) Patent Application Publication
(10) Pub. No.: US 2019/0138432 A1
(43) Pub. Date: May 9, 2019

(54) TEST CASE STANDARDIZATION AND AUTOMATIC TEST SCRIPT GENERATION

(71) Applicant: Magna Electronics Inc., Auburn Hills, MI (US)

(72) Inventors: Shreyas C. Nagaraj, Farmington Hills, MI (US); Gregory Pasquesoone, Waterford Twp, MI (US)

(21) Appl. No.: 16/177,549

(22) Filed: Nov. 1, 2018

Related U.S. Application Data
(60) Provisional application No. 62/581,938, filed on Nov. 6, 2017.

(51) Int. Cl. G06F 11/36

(52) U.S. Cl. CPC G06F 11/3688; G06F 11/3696; G06F 11/3684

(57) ABSTRACT

A test process for a vehicular product or system includes generating, by data processing hardware, standardized test cases for testing requirements of a vehicular product or a vehicular system, automatically generating, by the data processing hardware, test scripts derived from the standardized test cases, performing tests, by the data processing hardware, on a product or system based on the test scripts, automatically generating, by the data processing hardware, test reports based on the performed tests, and automatically uploading, by the data processing hardware, the test reports to a product lifecycle management tool.

### CROSS REFERENCE TO RELATED APPLICATION

The present application claims the filing benefits of U.S. provisional application Ser. No. 62/581,938, filed Nov. 6, 2017, which is hereby incorporated herein by reference in its entirety.

### FIELD OF THE INVENTION

The present invention relates generally to a test system for a vehicle and, more particularly, to a vehicle test system that provides standardized test cases and automatic generation of test scripts and automatic uploading of test reports in testing product lifecycles.

### BACKGROUND OF THE INVENTION

Typically, when generating tests for various products or systems of a vehicle, an engineer writes a test case and a test script is manually derived for the test case. The testing system performs the tests and a test report is manually uploaded to a product lifecycle management (PLM) tool, such as PTC Integrity or the like. A schematic of such a process and system is shown in FIG. 1.

### SUMMARY OF THE INVENTION

The present invention provides a standardization process for writing test cases, whereby the test script (based on the standardized test case(s)) is automatically generated by data processing hardware, and the test reports (generated after performing tests based on the automatically generated test scripts) are automatically uploaded by data processing hardware to a PLM tool. Along with uploading the automatically generated test report and verdict to the PLM tool, the system may also upload the raw data log file to the PLM tool.

These and other objects, advantages, purposes and features of the present invention will become apparent upon review of the following specification in conjunction with the drawings.

### BRIEF DESCRIPTION OF THE DRAWINGS

FIG. 1 is a schematic showing development of test cases and scripts and test reports via manual entry of information;

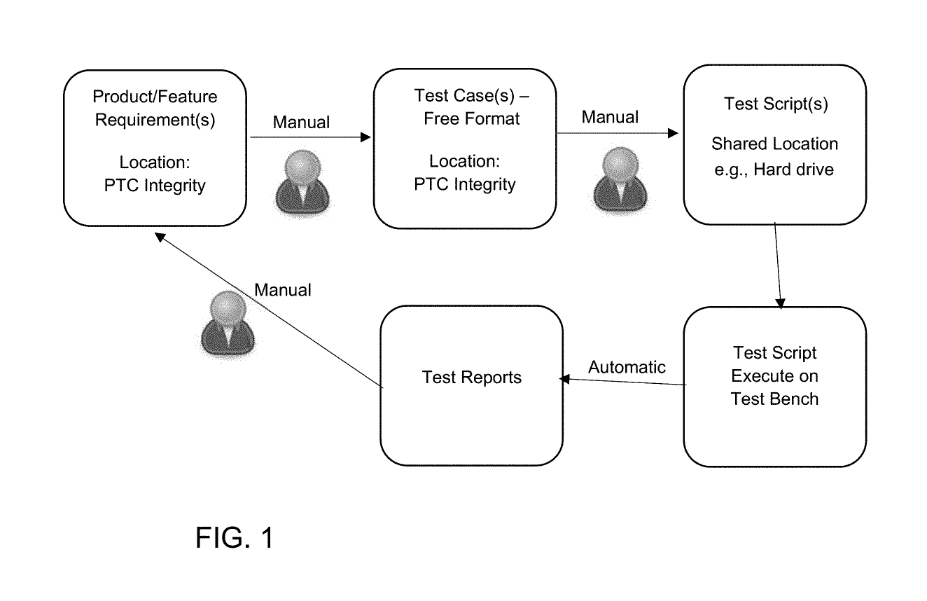

FIG. 2 is a schematic showing development of standard test cases and automatic generation of scripts and reports in accordance with the present invention; and

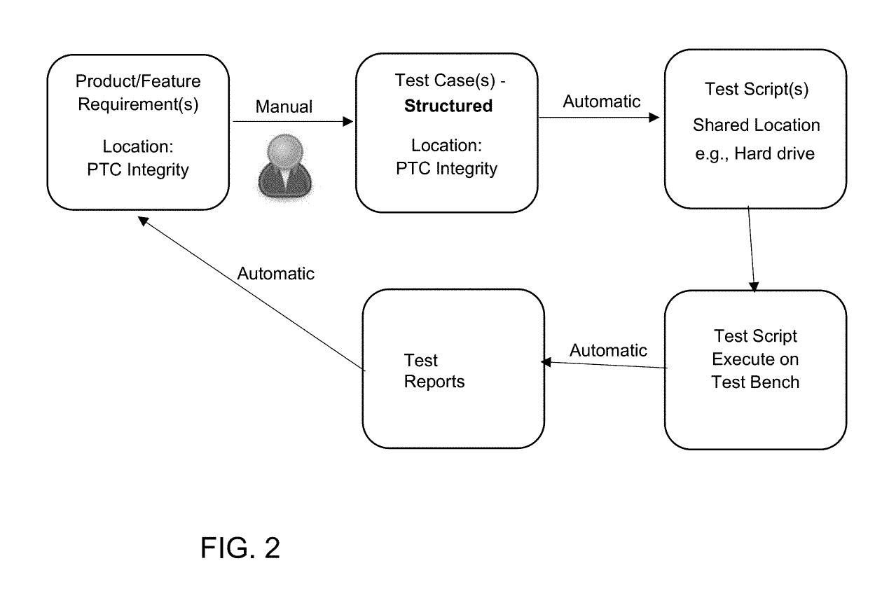

FIG. 3 is a schematic of an exemplary computing device that may be used to implement the development of standard test cases and automatic generation of scripts and reports.

### DESCRIPTION OF THE PREFERRED EMBODIMENTS

In determining testing for a product, the requirements include a list of specifications for the product/feature that is authored in the PLM tool. The test cases are developed by engineers and are written to test a particular requirement. There could be one or more test case(s) to satisfy each requirement of the product/feature. Test cases are written in plain spoken language and contain sentences, variables, numbers, equations, etc. A test script is derived from a test case. The test script is written in scripting tools, such as Python, dSPACE AutomationDesk, PERL, etc., and is normally executed on a simulator tool. The script is basically a machine readable description of the test case and is a command set for the test tool to perform the required functions automatically. There are one or more test script(s) per test case. After the test script is executed on the test bench, a test report is automatically generated. The summary of the test report contains a verdict for the test (such as, for example, pass, fail, no result). An engineer then manually uploads each test report along with the verdict to the PLM tool. This takes a lot of time since there may be several hundred test cases for a particular test session.

The test cases are written in spoken language. Because known processes do not have a standard defined to author test cases, it is left to the engineer's own ability/style to write test cases. This leads to a non-uniform set of test cases which often causes ambiguity and interpretation problems to a new person reading the test cases. The problem is amplified when people from different regions of the world try to read the test cases. Another problem is that sometimes the test cases have missing information which leads to delays and incorrect testing.

The present invention provides test case standardization by executing a testing system on data processing hardware. The data processing hardware may be, for example, a single computer, multiple computers, or a distributed system (e.g., a cloud environment) having scalable/elastic computing resources and/or storage resources (e.g., memory hardware). By standardizing the test case write-ups, the system may automate test script generation and report generation and uploading. With a predefined way of writing test cases, the system not only reduces the ambiguity in the test cases but also allows for programming of a computer to automatically generate test scripts from the test cases. This saves a lot of time and reduces errors in test script creation (since this is currently done manually).

The system of the present invention also provides automatic test report uploading to the PLM tool. The process of uploading the generated test cases along with the corresponding verdict (such as, for example, pass, fail or no result for that test) is automatically uploaded to the PLM tool. This saves a lot of time and does not require a person to accomplish this task. This saves a lot of time since there will be several hundred test cases for a particular test session. Along with automatically uploading the automatically generated test report and verdict to the PLM tool, the system may also upload the raw data log file to the PLM tool, such as for further processing.

Thus, the system or process of the present invention provides for standardizing test cases, which leads to automation of test scripts and report uploading. By standardizing the way test cases are written not only does the system reduce ambiguity and improve clarity but it also makes the test cases machine readable which facilitates automation in developing the test scripts. This also improves clarity and provides a uniform way of authoring test cases. Since the process of developing test scripts from tests cases is automated, it not only reduces time but also avoids or eliminates human error.

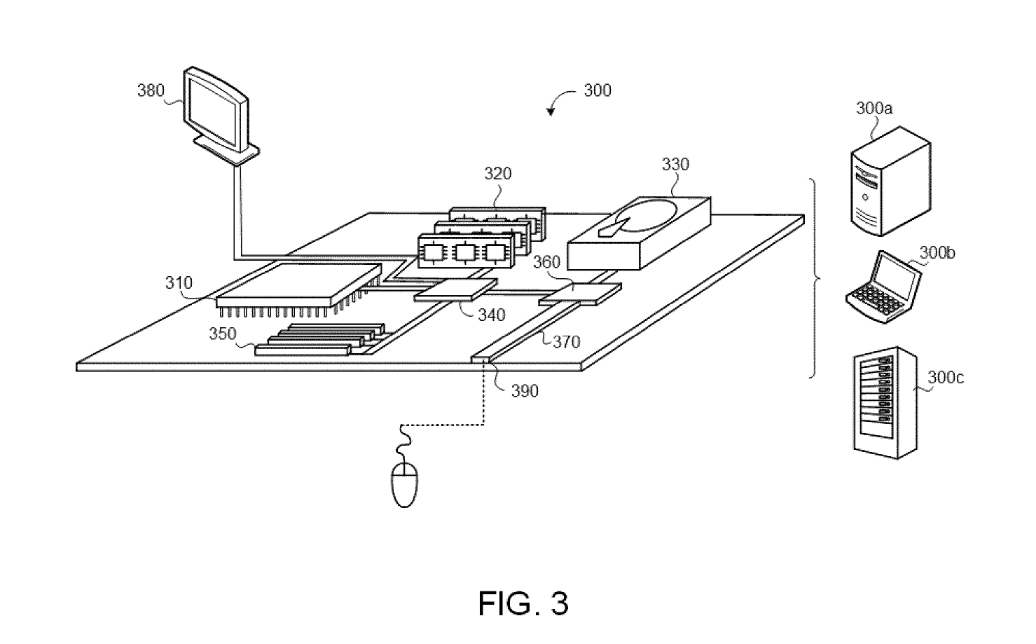

FIG. 3 is schematic view of an example computing device 300 that may be used to implement the test processes or systems or methods for a vehicular product or system. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as a display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-readable or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, BLUETOOTH®, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Changes and modifications in the specifically described embodiments can be carried out without departing from the principles of the invention, which is intended to be limited only by the scope of the appended claims, as interpreted according to the principles of patent law including the doctrine of equivalents.

1. A test process for a vehicular product or system, said test process comprising:
generating, by data processing hardware, standardized test cases for testing requirements of a vehicular product or a vehicular system;
generating, by the data processing hardware, test scripts derived from the standardized test cases;
performing, by the data processing hardware, tests on a product or system based on the test scripts;
generating, by the data processing hardware, test reports based on the performed tests; and
uploading, by the data processing hardware, the test reports to a product lifecycle management tool.

2. The test process of claim 1, wherein the tests comprise bench tests.

3. The test process of claim 1, wherein generating test scripts comprises generating tests scripts derived from the standardized test cases without any other input.

4. The test process of claim 1, wherein generating standardized test cases comprises generating structured test cases and not free form.

5. The test process of claim 1, comprising uploading, by data processing hardware, a verdict for each respective test to the product lifecycle management tool.

6. The test process of claim 5, wherein the verdict comprises a pass verdict, a fail verdict or a no result verdict.

7. The test process of claim 1, wherein performing tests on the product or system based on the test scripts includes generating and collecting raw data.

8. The test process of claim 7, comprising processing, by the data processing hardware, the raw data to generate the test reports.

9. The test process of claim 8, comprising uploading, by the data processing hardware, the raw data to the product lifecycle management tool.

10. A test process for a vehicular product or system, said test process comprising:
generating, by data processing hardware, standardized test cases for testing requirements of a vehicular product or a vehicular system;
generating, by the data processing hardware, test scripts derived from the standardized test cases;
performing, by the data processing hardware, bench tests on a product or system based on the test scripts;
generating, by the data processing hardware, test reports based on the performed tests;
uploading, by the data processing hardware, the test reports to a product lifecycle management tool; and
uploading, by data processing hardware, a verdict for each respective test to the product lifecycle management tool.

11. The test process of claim 10, wherein generating test scripts comprises generating tests scripts derived from the standardized test cases without any other input.

12. The test process of claim 10, wherein generating standardized test cases comprises generating structured test cases and not free form.

13. The test process of claim 10, wherein the verdict comprises a pass verdict, a fail verdict or a no result verdict.

14. The test process of claim 10, wherein performing tests on the product or system based on the test scripts includes generating and collecting raw data.

15. The test process of claim 14, comprising processing, by the data processing hardware, the raw data to generate the test reports.

16. The test process of claim 15, comprising uploading, by the data processing hardware, the raw data to the product lifecycle management tool.

17. A test process for a vehicular product or system, said test process comprising:
generating, by data processing hardware, standardized structured test cases for testing requirements of a vehicular product or a vehicular system;
generating, by the data processing hardware, test scripts derived from the standardized test cases without any other input;
performing, by the data processing hardware, tests on a product or system based on the test scripts;
generating, by the data processing hardware, test reports based on the performed tests; and
uploading, by the data processing hardware, the test reports to a product lifecycle management tool.

18. The test process of claim 17, wherein performing tests on the product or system based on the test scripts includes generating and collecting raw data.

19. The test process of claim 18, comprising processing, by the data processing hardware, the raw data to generate the test reports.

20. The test process of claim 19, comprising uploading, by the data processing hardware, the raw data to the product lifecycle management tool.
